(19) United States
(12) Patent Application Publication
(10) Pub. No.: US 2015/0269207 A1
(43) Pub. Date: Sep. 24, 2015

(54) SIMPLE AND EFFICIENT METHOD FOR RECYCLING DEVICE IDENTIFIERS

(71) Applicant: Cong Deng, Richardson, TX (US)

(72) Inventor: Cong Deng, Richardson, TX (US)

(21) Appl. No.: 14/218,164

(22) Filed: Mar. 18, 2014

(51) Int. Cl. G06F 17/30; H04L 29/12

(52) U.S. Cl. CPC G06F 17/30339; H04L 61/3015; G06F 17/30117

(57) ABSTRACT

A method and system for simple and efficient recycling of entity IDs in a network may rely upon two tables storing records associated with a particular entity ID while avoiding the use of timestamps or a common time source. A first table may store X number of records associated with active entities, including active entity IDs. A second table, referred to herein as an entity ID table, may store Y number of records associated with deactivated entities, including available entity IDs for reuse and a delete index, which may record an ordinal value associated with deactivated entity IDs. The two tables may enable fast and computationally efficient recycling of entity IDs without having to perform costly sorting operations and without the use of timestamps or a common time source.

### BACKGROUND

1. Field of the Disclosure

The present disclosure relates to communications systems and more specifically to simple and efficient method for recycling device identifiers.

2. Description of the Related Art

A communication network may include network elements that route packets through the network. Some network elements may include a distributed architecture, wherein packet processing may be distributed among several subsystems of the network element (e.g., line cards). Thus, network elements may be modular and may include various subsystems and/or subelements, which may be represented as logical and/or physical entities. The logical and/or physical entities included in a network element may refer to the network element, a shelf, a slot, a port, a channel and/or various combinations thereof.

Throughout the network, the entities may be referenced by various control elements and/or software applications. For the purposes of addressing a specific entity, each entity may be assigned an entity identifier (ID) that is unique throughout a desired domain. In typical networks, the entity IDs may be automatically generated as a numerical value whose extent is referred to as a name space for the entity ID. Because the name space of the entity ID may be limited to a certain maximum number of IDs given by the extent (e.g., the entity ID may be constrained to a 32-bit number by certain network protocols), all available unused entity IDs may become consumed by deactivated entities during the course of normal network operations, which is undesirable because new entities may then be prevented from being added to network operations.

However, because a logical and/or physical entity associated with an entity ID may also be deleted during normal network operations, entity IDs may be discarded during normal network operations, resulting in previously used entity IDs that may be available for reuse and/or recycle. When a timestamp is used to keep track of which entity ID is an oldest or earliest ID, a significant difficulty arises in defining a common, sufficiently accurate, and secure time source throughout the network, which may render time-based recycling methods for entity IDs impractical and overly complex.

### BRIEF DESCRIPTION OF THE DRAWINGS

For a more complete understanding of the present invention and its features and advantages, reference is now made to the following description, taken in conjunction with the accompanying drawings, in which:

FIG. 1 is a block diagram of selected elements of an embodiment of a network;

FIG. 2 is a block diagram of selected elements of an embodiment of a network element;

FIG. 3A is a diagram of selected elements of an embodiment of an entity table;

FIG. 3B is a diagram of selected elements of an embodiment of an entity ID table;

FIG. 4A is a diagram of selected elements of an embodiment of an entity table;

FIG. 4B is a diagram of selected elements of an embodiment of an entity ID table;

FIG. 5A is a diagram of selected elements of an embodiment of an entity ID table;

FIG. 5B is a diagram of selected elements of an embodiment of an entity table;

FIG. 6 is a diagram of selected elements of an embodiment of an entity ID table; and

FIG. 7 is a flow chart depicting selected elements of an embodiment of a method for efficient recycling of entity IDs.

### SUMMARY

In one aspect, a disclosed method for recycling device identifiers includes maintaining device records respectively corresponding to active devices in an entity table. A device record in the entity table may include a device identifier (ID).

When an active device is deactivated, the method may include deleting, from the entity table, a first device record corresponding to the active device. The method may include adding, to an entity ID table, a first entity ID record including a first device ID associated with the first device record, and incrementing a delete index value in the entity ID table associated with the first entity ID record. The delete index value may be incremented from a maximum value of delete index values stored in the entity ID table.

When an inactive device is activated, the method may include recycling a second entity ID from the entity identifier table. The method operations for recycling the second entity ID may include selecting the second entity ID record based on a minimum value of delete index values stored in the entity ID table, adding, to the entity table, a second device record including a second device ID included in the second entity ID record, and deleting the second entity ID record from the entity ID table.

Additional disclosed aspects for recycling device identifiers include a network element and an article of manufacture comprising non-transitory computer readable memory media storing processor-executable instructions.

### DESCRIPTION OF PARTICULAR EMBODIMENT(S)

In the following description, details are set forth by way of example to facilitate discussion of the disclosed subject matter. It should be apparent to a person of ordinary skill in the field, however, that the disclosed embodiments are exemplary and not exhaustive of all possible embodiments.

As used herein, a hyphenated form of a reference numeral refers to a specific instance of an element and the un-hyphenated form of the reference numeral refers to the collective or generic element. Thus, for example, widget 12-1 refers to an instance of a widget class, which may be referred to collectively as widgets 12 and any one of which may be referred to generically as a widget 12.

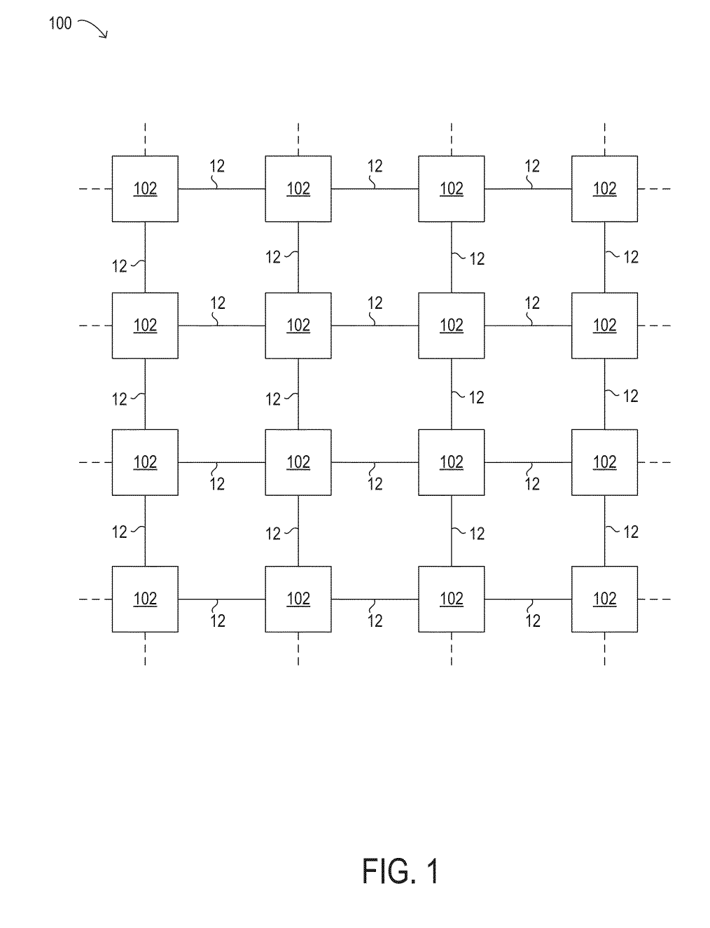

Turning now to the drawings, FIG. 1 is a block diagram showing selected elements of an embodiment of network 100. In certain embodiments, network 100 may be an Ethernet network. Network 100 may include one or more transmission media 12 operable to transport one or more signals communicated by components of network 100. The components of network 100, coupled together by transmission media 12, may include a plurality of network elements 102. In the illustrated network 100, each network element 102 is coupled to four other nodes. However, any suitable configuration of any suitable number of network elements 102 may create network 10. Although network 100 is shown as a mesh network, network 100 may also be configured as a ring network, a point-to-point network, or any other suitable network or combination of networks. Network 10 may be used in a short-haul metropolitan network, a long-haul inter-city network, or any other suitable network or combination of networks.

Each transmission medium 12 may include any system, device, or apparatus configured to communicatively couple network devices 102 to each other and communicate information between corresponding network devices 102. For example, a transmission medium 12 may include an optical fiber, an Ethernet cable, a T1 cable, a WiFi signal, a Bluetooth signal, and/or other suitable medium.

Network 100 may communicate information or “traffic” over transmission media 12. As used herein, “traffic” means information transmitted, stored, or sorted in network 100. Such traffic may comprise optical or electrical signals configured to encode audio, video, textual, and/or any other suitable data. The data may also be transmitted in a synchronous or asynchronous manner, and may transmitted deterministically (also referred to as ‘real-time’) and/or stochastically. Traffic may be communicated via any suitable communications protocol, including, without limitation, the Open Systems Interconnection (OSI) standard and Internet Protocol (IP). Additionally, the traffic communicated via network 100 may be structured in any appropriate manner including, but not limited to, being structured in frames, packets, or an unstructured bit stream.

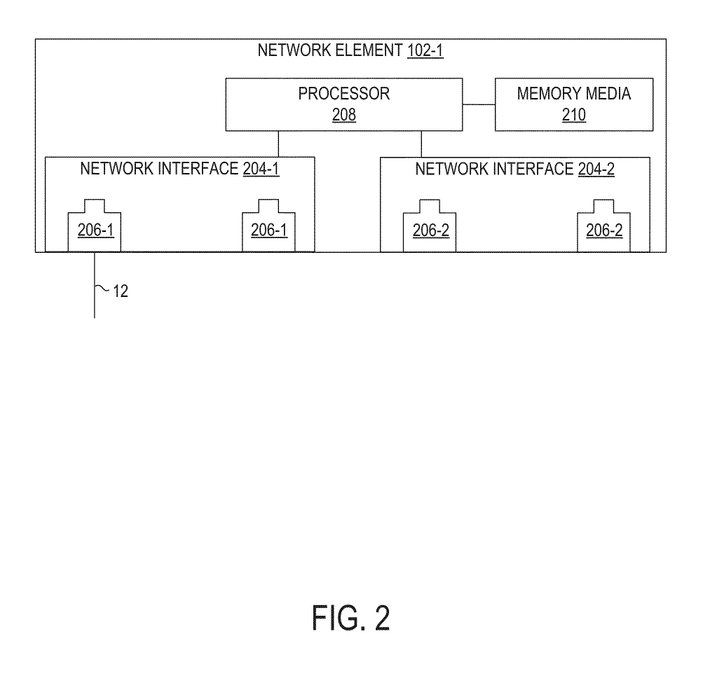

Each network element 102 in network 100 may comprise any suitable system operable to transmit and receive traffic. In the illustrated embodiment, each network element 102 may be operable to transmit traffic directly to one or more other network elements 102 and receive traffic directly from the one or more other network elements 102. Network elements 102 will be discussed in more detail below with respect to FIG. 2.

Modifications, additions, or omissions may be made to network 100 without departing from the scope of the disclosure. The components and elements of network 100 described may be integrated or separated according to particular needs. Moreover, the operations of network 100 may be performed by more, fewer, or other components.

In operation, various physical and/or logical entities may be configured within network 100. The logical and/or physical entities may be assigned entity IDs to enable specific addressing of desired entities. In network 100, a simple and efficient entity ID recycling method, as described herein, may be employed, which does not rely on or use timestamps to determine an order of entity IDs.

Referring now to FIG. 2, a block diagram of selected elements of an embodiment of network element 102-1, which is represented as a particular embodiment of network elements 102 for descriptive purposes, is illustrated. Network element 102-1, as shown, includes processor 208 and memory media 210, along with network interface 204-1 having ports 206-1 and network interface 204-2 having ports 206-2.

As depicted in FIG. 2, each network element 102 may include processor 208 and memory media 210 that may store instructions executable by processor 208. As shown, memory media 210 may represent volatile, non-volatile, fixed, and/or removable media, and may be implemented using magnetic and/or semiconductor memory. Memory media 210 is capable of storing instructions (i.e., code executable by processor 208) and/or data. Memory media 210 and/or at least a portion of contents of memory media 210 may be implemented as an article of manufacture comprising non-transitory computer readable memory media storing processor-executable instructions. Memory media 210 may store instructions including an operating system (OS), which may be any of a variety of operating systems, such as a UNIX variant, LINUX, a Microsoft Windows® operating system, or a different operating system. It is noted that network interface 204 may also include a processor and memory media (not shown) in certain embodiments. A processor and memory included with network element 102, such as processor 208 and memory media 210 or another processor and memory media, may implement a simple and efficient method for recycling entity IDs, as described herein.

In FIG. 2, network elements 102 are shown including at least one network interface 204, which provides a plurality of ports 206 that receive a corresponding transmission media 12 (see also FIG. 1). Ports 206 and transmission media 12 may represent galvanic and/or optical network connections. Each network interface 204 may include any suitable system, apparatus, or device configured to serve as an interface between a network element 102 and transmission medium 12. Each network interface 204 may enable its associated network element 102 to communicate with other network elements 102 using any of a variety of transmission protocols and/or standards. Network interface 204 and its various components may be implemented using hardware, software, or any combination thereof. In certain embodiments, network interfaces 204 may include a network interface card. In various embodiments, network interfaces 204 may include a line card. Each port 206 may include a system, device or apparatus configured to serve as a physical interface between corresponding transmission medium 12 and network interface 204. In some embodiments, port 206 may comprise an Ethernet port. Although in FIG. 2 network interfaces 204 are shown with 2 instances of ports 206 for descriptive clarity, in different embodiments, network interfaces 204 may be equipped with different numbers of ports 206 (e.g., 4, 6, 8, 16 ports, etc.). In various embodiments, network element 102 may be configured to receive data and route such data to a particular network interface 204 and/or port 206 based on analyzing the contents of the data and/or based on a characteristic of a signal carrying the data (e.g., a wavelength and/or modulation of the signal). In certain embodiments, network element 102 may include a switching element (not shown) that may include a switch fabric (SWF).

As noted previously, the various components included in network element 102 may be referenced by various controllers and/or software modules during network operation. For the purposes of addressing, one or more components may be designated as an entity having an entity ID. The entity ID for entities included in a network element may be unique in a given domain, for example, within a given instance of network element 102, which may have its own unique entity ID. In this manner, various entities, representing individual components or combined groups of components, may be defined and may be distinctly addressable using entity IDs. In various embodiments, groups of components may be combined into an entity having an entity ID based on a functional purpose within network 100.

As will be described in further detail, a simple and efficient method for recycling entity IDs in network 100 may rely upon two tables storing records associated with a particular entity ID while avoiding the use of timestamps or a common time source. A first table, referred to herein as an entity table, may store X number of records associated with active (i.e., currently in use) entities, including active entity IDs. A second table, referred to herein as an entity ID table, may store Y number of records associated with deactivated (i.e., previously used, retired, deleted) entities, including available entity IDs for reuse (i.e., recycling), and a delete index, which may record an ordinal value associated with deactivated entity IDs. The two tables may enable fast and computationally efficient recycling of oldest entity IDs without having to perform costly sorting operations and without the use of timestamps or a common time source. After the number of active entities plus the number of deactivated entities have reached the name space extent N with regard to the entity ID, the name space N for the entity ID may be given by X+Y=N. For example, when entity IDs are unsigned integer values, N may represent the extent of the integer name space. For example, a 16-bit name space may correspond to the different unique entity IDs given by Nε[0 . . . 2¹⁶−1] or [0 . . . 65,535]. The methods and systems described herein are usable with different sized name spaces, as desired.

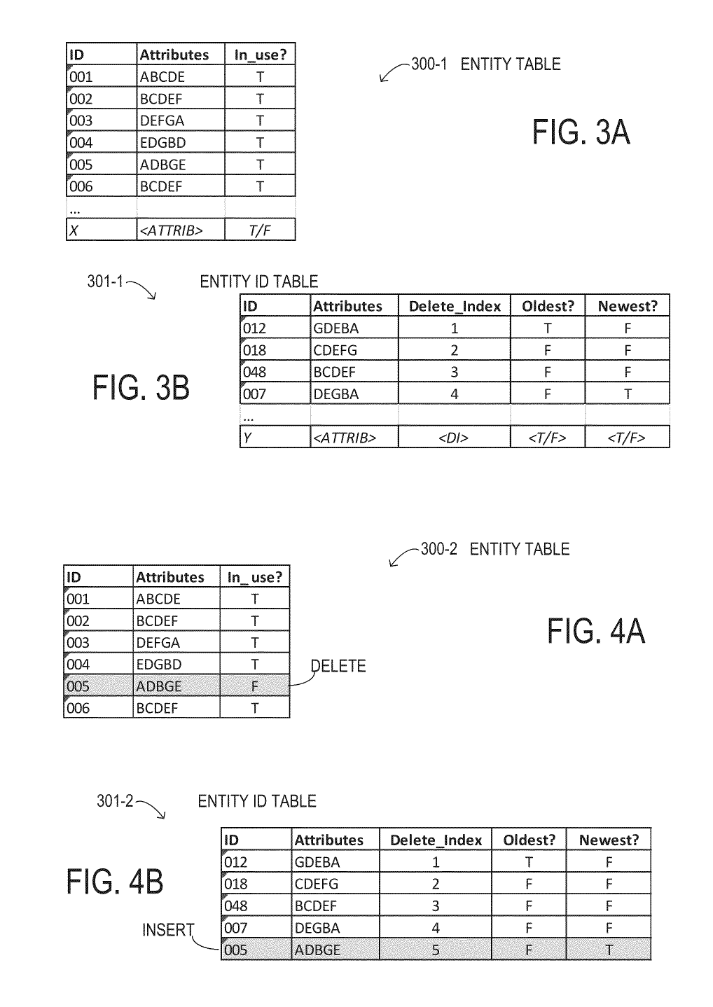

Referring now to FIG. 3A, a diagram depicting selected elements of an embodiment of entity table 300-1 is illustrated. In various embodiments, entity table 300-1 may represent structured data, for example, in a database (not shown). As shown, entity table 300-1 may be populated with X number of records (i.e., rows), of which 6 records are shown in detail for descriptive clarity. In FIG. 3A, entity table 300-1 is shown including the fields (i.e. columns): ID, Attributes, In_use?. In entity table 300-1, ID is a label for entity IDs (also referred to herein as device IDs), while Attributes are arbitrary parameters, which may respectively be depicted as alphabetic and/or alphanumeric code used for describing features associated with a given entity ID. Although Attributes are shown with unique values for a given entity ID for descriptive clarity, it is noted that in other embodiments (not shown), Attributes may store common values for different records. As shown, In_use? may represent a boolean field (i.e., a flag) storing boolean values T (true) and F (false), though other boolean representations, such as 0 and 1, may be used in different embodiments. It is noted that in certain embodiments, the field In_use? may be omitted. In operation, as new entities are created, entity table 300-1 may be populated with corresponding records that include ID (entity ID) for active entities (also referred to herein as active devices). At first, new entity IDs may be sequentially generated and stored in entity table 300-1 by incrementing a previous maximum entity ID value for activated entities. As entity IDs are deactivated and become available for reuse, previously inactive entity IDs may be assigned as recycled entity IDs, as will now be described in further detail.

Referring now to FIG. 3B, a diagram depicting selected elements of an embodiment of entity ID table 301-1 is illustrated. In various embodiments, entity ID table 301-1 may represent structured data, for example, in a database (not shown). As shown, entity ID table 301-1 may be populated with Y number of records (i.e., rows), of which 4 records are shown in detail for descriptive clarity. In FIG. 3B, entity ID table 301-1 is shown including the fields (i.e. columns): ID, Attributes, Delete_Index, Oldest?, Newest?. In entity ID table 301-1, ID is a label for entity IDs, while Attributes is the same field as in entity table 300-1. As shown, Delete_Index may represent an ordinal value that records an order in which entity IDs are deactivated and stored in entity ID table 301-1, while Oldest? and Newest? are boolean fields (i.e., a flags) storing boolean values T (true) and F (false), though other boolean representations, such as 0 and 1, may be used in different embodiments. In entity ID table 301-1 Oldest? stores a single T value for an oldest record while Newest? stores a single T value for a newest record. The fields Oldest? and Newest? may be used to reduce a number of sort operations performed on Delete_Index and/or for other purposes related to computational efficiency. Accordingly, in certain embodiments, the fields Oldest? and Newest? may be omitted.

Referring now to FIG. 4A, a diagram depicting selected elements of an embodiment of entity table 300-2 is illustrated. As shown, entity table 300-2 may represent an embodiment of entity table 300-1, which has been limited to 6 records for descriptive clarity. In FIG. 4A, entity table 300-2 depicts a delete operation for the record having an entity ID of ‘005’. In the example shown, In_use? is set to F indicating that the record is no longer activated. At some later time, the record with ID=005 may be deleted from entity table 300-2.

Referring now to FIG. 4B, a diagram depicting selected elements of an embodiment of entity ID table 301-2 is illustrated. As shown, entity ID table 301-2 may represent an embodiment of entity ID table 301-1, which includes the same 4 records for descriptive clarity. Corresponding to entity table 300-2 in FIG. 4A, the record that was deleted is inserted into entity ID table 301-2 as a deactivated entity with entity ID of ‘005’. Upon insertion into entity ID table 301-2, a Delete_Index value of ‘5’ is given to the inserted record, with Oldest?=F and Newest?=T. Simultaneously, the previous record with Newest?=T (ID=007, see entity ID table 301-1 in FIG. 3B) is changed to Newest?=F. In this manner, the newest record in entity ID table 301-2 is designated with a maximum value for Delete_Index and a single T value in Newest?.

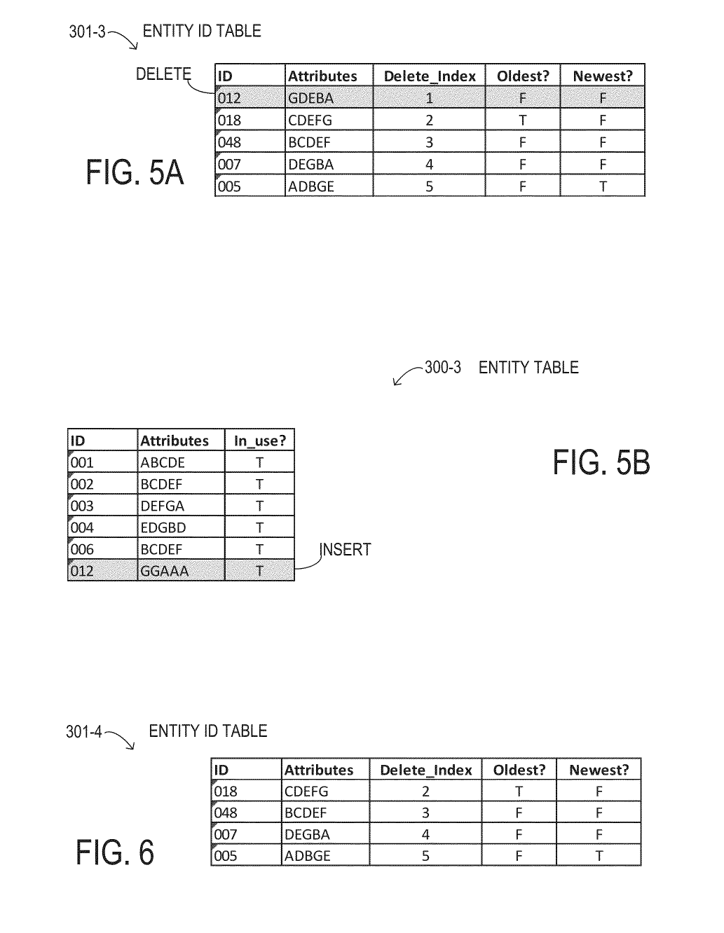

Referring now to FIG. 5A, a diagram depicting selected elements of an embodiment of entity ID table 301-3 is illustrated. As shown, entity ID table 301-3 may represent an embodiment of entity ID table 301-2 (see FIG. 4B). Entity ID table 301-3 depicts recycling of an oldest record with ID=012 and having Oldest?=T (see FIG. 4B). In order to recycle the oldest record, the record is deleted from entity ID table 301-3 while Oldest? is updated with a T value for a new minimum value of Delete_Index for record ID=018, which was previously F (see entity ID table 301-2 in FIG. 4B). It is noted that the deleted record may be buffered or temporarily stored prior to actual deletion from entity ID table 301-3.

Referring now to FIG. 5B, a diagram depicting selected elements of an embodiment of entity table 300-3 is illustrated. As shown, entity table 300-3 may represent an embodiment of entity table 300-2 (see FIG. 4A), which depicts recycling of record ID=012 as described with respect to FIG. 5A. The entity record with recycled ID=012 and Attributes=GGAAA, representing new attribute values that are different from Attributes for any active and inactive entity, is inserted into entity table 300-3 and In_use? is set to T, which may indicate that the entity is now active.

Referring now to FIG. 6, a diagram depicting selected elements of an embodiment of entity ID table 301-4 is illustrated. As shown, entity ID table 301-4 may represent an embodiment of entity ID table 301-3 (see FIG. 5A) after the deletion of the recycled entity ID record. It is noted that in entity ID table 301-4, Delete_Index now has values ranging from 2 to 5 for the 4 records stored therein.

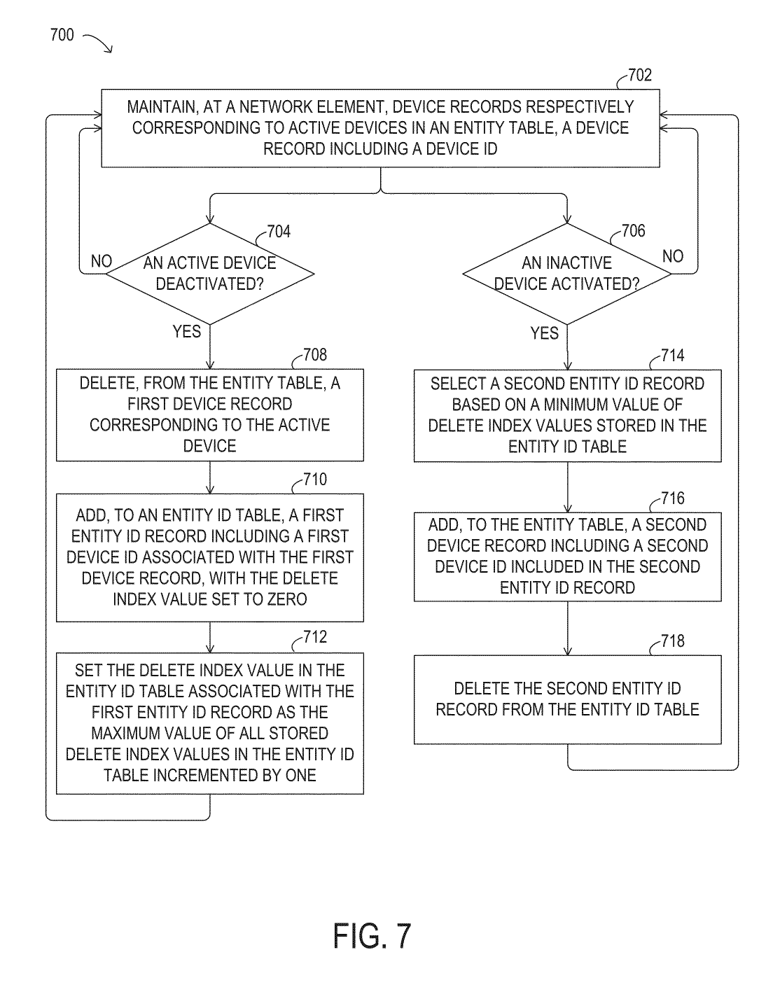

Turning now to FIG. 7, a block diagram of selected elements of an embodiment of method 700 for recycling entity IDs is depicted in flow-chart form. Method 700 may be performed using network element 102 (see FIGS. 1 and 2). It is noted that certain operations described in method 700 may be optional or may be rearranged in different embodiments.

In FIG. 7, method 700 may begin by maintaining (operation 702), at a network element, device records respectively corresponding to active devices in an entity table, wherein a device record includes a device ID. Then, method 700 may perform two separate operations, beginning with operations 704 and 706, corresponding to deactivating an active device and activating an inactive device, as desired.

In method 700, a decision may be made whether an active device is deactivated (operation 704). When the result of operation 704 is NO, method 700 may return to operation 702. When the result of operation 704 is YES, a first device record corresponding to the active device may be deleted (operation 708) from the entity table. Then, a first entity ID record including a first device ID associated with the first device record may be added (operation 710) to an entity ID table with a Delete_Index value set to a default value of zero. In various embodiments, a different default value than zero may be used in operation 710. A Delete_Index value associated with the first entity ID record in the entity ID table may then be set (operation 712) to a maximum value of all stored Delete_Index values in the entity ID table incremented by one. In certain embodiments, other increments than one may be used. After operation 712, method 700 may loop back to operation 702.

In method 700, a decision may be made whether an inactive device is activated (operation 706). An inactive device may represent a device that is currently not active and does not have a record in the entity table. It is noted that an inactive device may have previously been an active device or may be a new device. When the result of operation 706 is NO, method 700 may return to operation 702. When the result of operation 706 is YES, a second entity ID record may be selected (operation 714) based on a minimum value of Delete_Index values stored in the entity ID table. A second device record including a second device ID included in the second entity ID record may be added (operation 716) to the entity table. The second entity ID record may be deleted (operation 718) from the entity ID table. After operation 718, method 700 may loop back to operation 702.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for recycling device identifiers, comprising:
maintaining device records respectively corresponding to active devices in an entity table, wherein a device record in the entity table includes a device identifier (ID);
when an active device is deactivated:
deleting, from the entity table, a first device record corresponding to the active device;
adding, to an entity ID table, a first entity ID record including a first device ID associated with the first device record and having a delete index value set to zero; and
incrementing the delete index value in the entity ID table associated with the first entity ID record, wherein the delete index value is incremented from a maximum value of delete index values stored in the entity ID table; and
when an inactive device is activated, recycling a second entity ID record from the entity identifier table, including:
selecting the second entity ID record based on a minimum value of delete index values stored in the entity ID table;
adding, to the entity table, a second device record including a second device ID included in the second entity ID record; and
deleting the second entity ID record from the entity ID table.

2. The method of claim 1, wherein recycling the second entity ID is performed when a namespace for device identifiers has been consumed by active devices represented in the entity table and deactivated devices represented in the entity ID table.

3. The method of claim 2, wherein the namespace for device identifiers is represented by a set of device IDs stored in the entity table and stored in the entity ID table.

4. The method of claim 1, further comprising:
when the namespace for device identifiers has not been consumed by active devices represented in the entity table and deactivated devices represented in the entity ID table and an inactive device is to be activated:
adding a third device record, including a third device ID, to the entity table, wherein the third device ID is incremented from a previous maximum value of device ID values stored in the entity table and the entity ID table.

5. The method of claim 1, wherein the entity ID table includes a first flag record indicating the maximum value of delete index values.

6. The method of claim 5, wherein the entity ID table includes a second flag record indicating the minimum value of delete index values.

7. The method of claim 1, wherein the entity ID table includes a binary record indicating the maximum value of delete index values and the minimum value of delete index values.

8. The method of claim 1, wherein the entity table and the entity ID table are stored in non-volatile memory of a network element, and wherein the active devices represent components included in the network element.

9. The method of claim 1, wherein a device record in the entity table further includes attributes associated with an active device.

10. A network element for recycling device identifiers, comprising:
a processor configured to access non-transitory computer readable memory media, wherein the memory media store processor-executable instructions, the instructions, when executed by a processor, cause the processor to:
maintain device records respectively corresponding to active devices in an entity table, wherein a device record in the entity table includes a device identifier (ID);
when an active device is deactivated, the instructions including instructions to:
delete, from the entity table, a first device record corresponding to the active device;
add, to an entity ID table, a first entity ID record including a first device ID associated with the first device record and having a delete index value set to zero; and
increment the delete index value in the entity ID table associated with the first entity ID record, wherein the delete index value is incremented from a maximum value of delete index values stored in the entity ID table; and
when an inactive device is activated, recycling a second entity ID record from the entity identifier table, including instructions to:
select the second entity ID record based on a minimum value of delete index values stored in the entity ID table;
add, to the entity table, a second device record, including a second device ID included in the second entity ID record; and
delete the second entity ID record from the entity ID table.

11. The network element of claim 10, wherein the instructions to recycle the second entity ID is performed when a namespace for device identifiers has been consumed by active devices represented in the entity table and deactivated devices represented in the entity ID table.

12. The network element of claim 11, wherein the namespace for device identifiers is represented by a set of device IDs stored in the entity table and stored in the entity ID table.

13. The network element of claim 10, further comprising instructions to:
when the namespace for device identifiers has not been consumed by active devices represented in the entity table and deactivated devices represented in the entity ID table and an inactive device is to be activated:
add a third device record, including a third device ID, to the entity table, wherein the third device ID is incremented from a previous maximum value of device ID values stored in the entity table and the entity ID table.

14. The network element of claim 10, wherein the entity ID table includes a first flag record indicating the maximum value of delete index values.

15. The network element of claim 14, wherein the entity ID table includes a second flag record indicating the minimum value of delete index values.

16. The network element of claim 10, wherein the entity ID table includes a binary record indicating the maximum value of delete index values and the minimum value of delete index values.

17. The network element of claim 10, wherein the entity table and the entity ID table are stored in non-volatile memory, and wherein the active devices represent components included in the network element.

18. The network element of claim 10, wherein a device record in the entity table further includes attributes associated with an active device.
